(19) United States
(12) Patent Application Publication
(10) Pub. No.: US 2013/0194209 A1
(43) Pub. Date: Aug. 1, 2013

(54) INFORMATION PROCESSING APPARATUS, INFORMATION PROCESSING METHOD, AND PROGRAM

(71) Applicant: Sony Corporation, Tokyo (JP)

(72) Inventors: Kazuo TSUKAGOSHI, Tokyo (JP); Masakazu KOYANAGI, Chiba (JP)

(73) Assignee: Sony Corporation, Tokyo (JP)

(21) Appl. No.: 13/710,698

(22) Filed: Dec. 11, 2012

(30) Foreign Application Priority Data
Jan. 26, 2012 (JP) 2012-014486

(51) Int. Cl. G06F 3/041

(52) U.S. Cl. CPC G06F 3/041
USPC 345/173

(57) ABSTRACT

There is provided an information processing apparatus including a detection part configured to detect a contact position of a substance with a touch panel having a first area and a second area, the second area being set to an invalidation area in which an operation of touching the first area with a substance is disabled by a contact of a substance, a determination part configured to determine whether the contact position is present within the first area, and a setting part configured to set the second area to a validation area in which an operation of touching the first area with a substance is enabled by a contact of a substance, in a case where the determination part determines that the contact position is present within the first area.

### BACKGROUND

The present disclosure relates to an information processing apparatus, an information processing method, and a program.

In recent years, a terminal equipped with a touch panel has been in widespread use as a device for accepting operation from a user. Examples of the terminal equipped with a touch panel include a mobile phone, a smartphone, and a digital camera. With the operation using the touch panel, the user can perform intuitive operation. Various techniques are disclosed as a technique related to a terminal equipped with a touch panel (for example, see JP 2011-134111A).

However, although the touch panel is excellent in operability, the touch panel also has characteristics that malfunction and failure likely occur when coming into contact with water, for example. With respect to the characteristics, terminals with waterproof properties are being developed. For example, there is a technique for setting the top, bottom, left, and right edges of a touch panel to an invalidation area, and controlling operation on the touch panel to be disabled in the case where the invalidation area comes into contact with water.

### SUMMARY

However, the top, bottom, left, and right edges of the touch panel are set to the invalidation area, and thus, a user's desired operation may be disabled in the case where the user touches the invalidation area unintentionally during the operation on the touch panel, for example. For example, in the case where the user performs an operation such as a tracing action on the touch panel, and when the user touches the invalidation area, the operation on the touch panel may be interrupted and the operability may be deteriorated.

In light of the foregoing, it is desirable to provide technology for improving operability on a touch panel without deteriorating waterproof properties.

According to an embodiment of the present disclosure, there is provided an information processing apparatus which includes a detection part configured to detect a contact position of a substance with a touch panel having a first area and a second area, the second area being set to an invalidation area in which an operation of touching the first area with a substance is disabled by a contact of a substance, a determination part configured to determine whether the contact position is present within the first area, and a setting part configured to set the second area to a validation area in which an operation of touching the first area with a substance is enabled by a contact of a substance, in a case where the determination part determines that the contact position is present within the first area.

According to another embodiment of the present disclosure, there is provided an information processing method which includes detecting a contact position of a substance with a touch panel having a first area and a second area, the second area being set to an invalidation area in which an operation of touching the first area with a substance is disabled by a contact of a substance, determining whether the contact position is present within the first area, and setting the second area to a validation area in which an operation of touching the first area with a substance is enabled by a contact of a substance, in a case where it is determined that the contact position is present within the first area.

According to another embodiment of the present disclosure, there is provided a program for causing a computer to function as an information processing apparatus which includes a detection part configured to detect a contact position of a substance with a touch panel having a first area and a second area, the second area being set to an invalidation area in which an operation of touching the first area with a substance is disabled by a contact of a substance, a determination part configured to determine whether the contact position is present within the first area, and a setting part configured to set the second area to a validation area in which an operation of touching the first area with a substance is enabled by a contact of a substance, in a case where the determination part determines that the contact position is present within the first area.

According to the embodiments of the present disclosure described above, the operability on the touch panel can be improved without deteriorating waterproof properties.

### BRIEF DESCRIPTION OF THE DRAWINGS

FIG. 1 is a diagram showing an example of an outline of an information processing apparatus according to an embodiment of the present disclosure;

FIG. 2 is a diagram (part 1) illustrating an overview of the information processing apparatus;

FIG. 3 is a diagram (part 2) illustrating an overview of the information processing apparatus;

FIG. 4 is a diagram (part 3) illustrating an overview of the information processing apparatus;

FIG. 5 is a block diagram showing a functional configuration example of the information processing apparatus;

FIG. 6 is a diagram illustrating an example of functions of the information processing apparatus;

FIG. 7 is a diagram illustrating another example of the functions of the information processing apparatus;

FIG. 8 is a diagram illustrating another example of the functions of the information processing apparatus;

FIG. 9 is a flowchart showing a flow of operation of the information processing apparatus;

FIG. 10 is a diagram showing an example of an outline of the information processing apparatus according to an embodiment of the present disclosure;

FIG. 11 is a diagram showing an example of an outline of the information processing apparatus according to an embodiment of the present disclosure; and

FIG. 12 is a diagram showing an example of an outline of the information processing apparatus according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, in this specification and the appended drawings, there are some cases where multiple structural elements that have substantially the same function and structure are distinguished from one another by being denoted with different alphabets after the same reference numeral. Note that, in the case where it is not necessary to distinguish the multiple structural elements that have substantially the same function and structure from one another, the multiple structural elements are denoted with the same reference numeral only.

Further, the “detailed description of the embodiment(s)” will be described in the order shown below.

1. Overview of information processing apparatus

2. Functions of information processing apparatus

3. Operation of information processing apparatus

4. Modified example

5. Conclusion

### 1. OVERVIEW OF INFORMATION PROCESSING APPARATUS

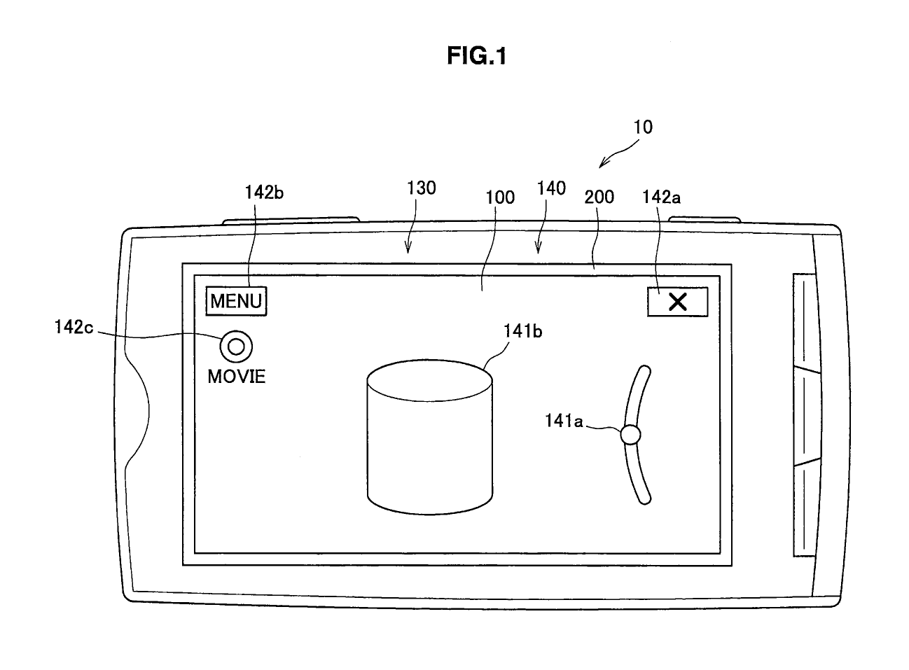

First, an overview of an information processing apparatus 10 according to an embodiment of the present disclosure will be described. FIG. 1 is a diagram showing an example of an external view of an information processing apparatus 10 according to an embodiment of the present disclosure. The information processing apparatus 10 is an example of a touch panel-equipped terminal. Although FIG. 1 shows an example in which the information processing apparatus 10 includes a touch panel 130 and a display part 140, the touch panel 130 and the display part 140 may be present outside the information processing apparatus 10. Further, although FIG. 1 shows a state in which the touch panel 130 and the display part 140 are provided in a stacked manner, the touch panel 130 and the display part 140 may be present in a separated state.

As shown in FIG. 1, the display part 140 displays objects 141a and 141b as examples of objects, which can be moved by an operation (hereinafter also referred to as “drag operation”) of moving an operating object in contact with the touch panel 130. Further, the display part 140 displays objects 142a, 142b, and 142c as examples of objects, which can be selected by an operation (hereinafter also referred to as “touch operation”) of bringing the operating object into contact with the touch panel 130. However, the types of objects displayed on the display part 140 are not particularly limited.

The touch panel 130 is provided with a first area and a second area. In the example shown in FIG. 1, a first area 100 is provided in a central area of the touch panel 130, and a second area 200 is provided in the left, right, top, and bottom edges of the touch panel 130 in a manner to surround the first area 100. However, respective positions at which the first area 100 and the second area 200 are provided are not particularly limited. Further, although in FIG. 1 the objects mentioned above are displayed in the first area 100, there may be objects which are displayed in the second area 200.

In an embodiment of the present disclosure shown below, description will be mainly made on how the information processing apparatus 10 controls each of the first area 100 and the second area 200. With such control, operability on the touch panel can be improved without deteriorating waterproof properties.

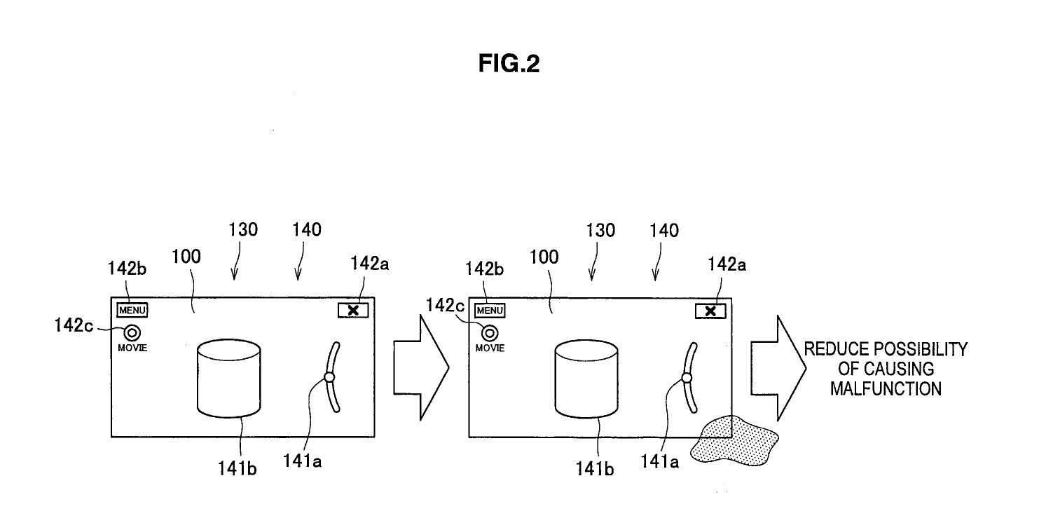

FIG. 2 is a diagram (part 1) illustrating an overview of the information processing apparatus 10 according to an embodiment of the present disclosure. First, let us assume that the first area 100 is set to a valid area. Here, the valid area represents an area in which an operation (for example, drag operation or touch operation) of touching with a substance is valid. Under the state set in this manner, if the state where the first area 100 is set to the valid area is retained where water comes into contact with the touch panel 130, the information processing apparatus 10 may cause malfunction.

Accordingly, in an embodiment of the present disclosure, we consider first to provide a function of reducing the possibility of causing such malfunction.

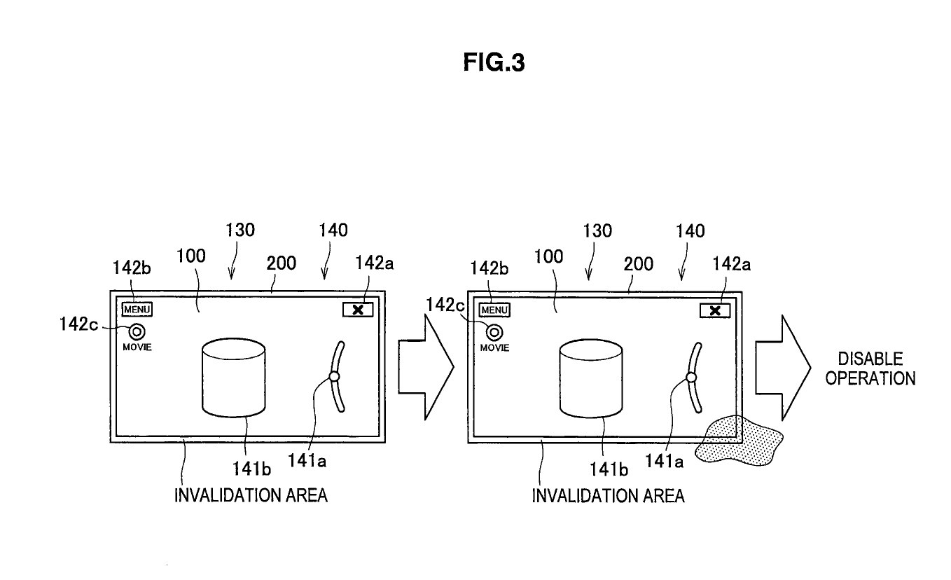

FIG. 3 is a diagram (part 2) illustrating an overview of the information processing apparatus 10 according to an embodiment of the present disclosure. In the same manner as the case shown in FIG. 2, let us assume that the first area 100 is set to the valid area. Further, let us assume that the second area 200 is set to an invalidation area. Here, the invalidation area represents an area in which the first area 100 is changed into an invalid area in the case where a contact of a substance with the invalidation area is detected. Here, the invalid area represents an area in which an operation (for example, drag operation or touch operation) of touching with a substance is invalid.

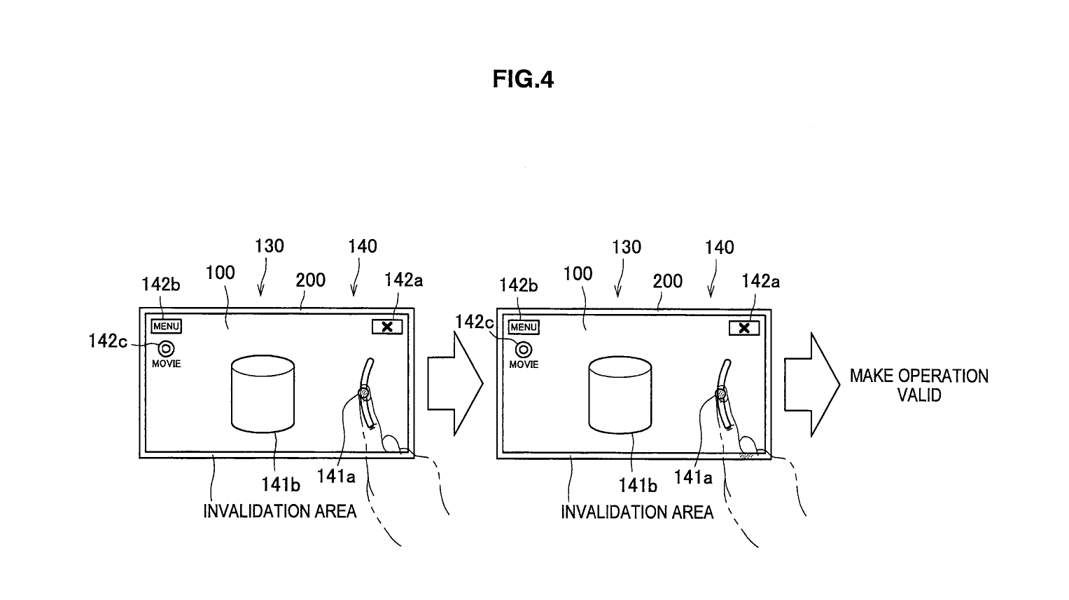

For example, under the state where the second area 200 is set to the invalidation area, in the case where a substance (for example, water) comes into contact with the second area 200, it is assumed that control is performed in a manner that the first area 100 is changed into the invalid area. With such control, the possibility of causing the malfunction as described above can be reduced. On the other hand, a situation as shown in FIG. 4 may also occur.

FIG. 4 is a diagram (part 3) illustrating an overview of the information processing apparatus 10 according to an embodiment of the present disclosure. In the same manner as the case shown in FIG. 3, let us assume that the first area 100 is set to the valid area. Further, in the same manner as the case shown in FIG. 3, let us assume that the second area 200 is set to the invalidation area.

For example, let us assume that under the state where the second area 200 is set to the invalidation area, a user performs an operation to an object. At this time, in the case where it is assumed that the control is performed in the same manner as shown in FIG. 3, the first area 100 is changed into the invalid area also when the user touches the second area 200 unintentionally, for example. As a result, the operation performed by the user is interrupted. Note that, for example, it is highly likely that, while moving a slider having a curved shape like the object 141a, the user may touch the second area 200 unintentionally.

Accordingly, in an embodiment of the present disclosure, it is assumed to provide a function of handling the operation performed by the user as a valid operation when the user accidentally touches the second area 200 during the operation to the touch panel 130, while maintaining the waterproof properties obtained by being provided with the second area 200.

Heretofore, an overview of the information processing apparatus 10 according to an embodiment of the present disclosure has been described. Next, functions of the information processing apparatus 10 according to an embodiment of the present disclosure will be described.

### 2. FUNCTIONS OF INFORMATION PROCESSING APPARATUS

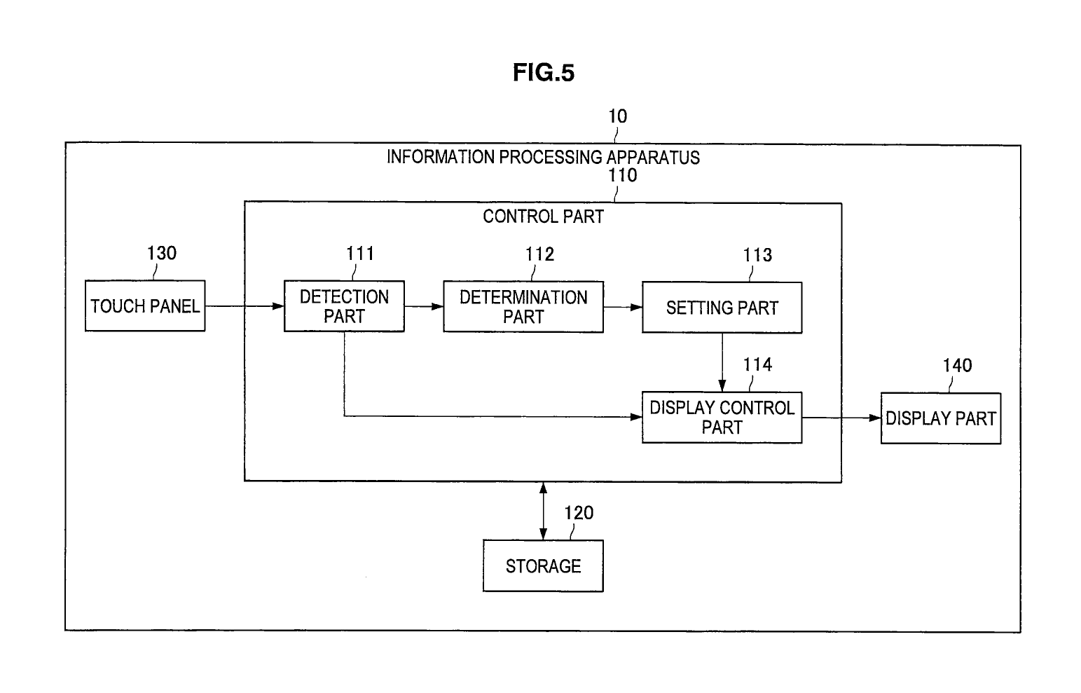

FIG. 5 is a block diagram showing a functional configuration example of the information processing apparatus 10 according to an embodiment of the present disclosure. As shown in FIG. 5, the information processing apparatus 10 includes a control part 110, a storage 120, a touch panel 130, and a display part 140. Further, the control part 110 includes a detection part 111, a determination part 112, a setting part 113, and a display control part 114.

The control part 110 corresponds to a processor such as a central processing unit (CPU) or a digital signal processor (DSP). The control part 110 exhibits various functions thereof by executing a program stored in the storage 120 or another storage medium.

The storage 120 stores a program for processing performed by the control part 110 and data, using a storage medium such as a semiconductor memory or a hard disk. Although in the example shown in FIG. 5 the storage 120 is built into the information processing apparatus 10, the storage 120 may be configured separately from the information processing apparatus 10.

The touch panel 130 detects a contact position with a substance. Further, in the case where there are multiple contact positions with the substance, the touch panel 130 may detect multiple contact positions. The detection result is output to the control part 110. It is assumed that the touch panel 130 is an electrostatic touch panel, for example, but may also be a touch panel of another type. The touch panel 130 may be included in the information processing apparatus 10, or may be present outside the information processing apparatus 10.

The detection part 111 detects a contact position of a substance with the touch panel 130. An expression form of the contact position is not particularly limited, and the contact position may be expressed using x and y coordinates, for example. Further, the substance to be brought into contact with the touch panel 130 may be an operating object (for example, finger or electronic pen) which is brought into contact with the touch panel 130 at the time of operation performed by a user, or may be a substance (for example, water) which is brought into contact with the touch panel 130 by a factor other than the operation performed by the user.

The determination part 112 determines whether the contact position detected by the detection part 111 is present within the first area 100. As shown in FIG. 1, the first area 100 may be provided in a central area of the touch panel 130, but since the first area 100 is not particularly limited, the first area 100 may be provided at another position. The case of the first area 100 being provided at another position will be described later.

In the case where the determination part 112 determines that the contact position detected by the detection part 111 is present within the first area 100, the setting part 113 sets the second area 200 to a validation area. Here, the validation area represents an area in which the first area 100 is changed into a valid area in the case where a contact of a substance with the validation area is detected. For example, in the case where the contact of the substance with the second area 200 is detected, the setting part 113 continuously sets the first area 100 to the valid area if the first area 100 has already been set to the valid area, and the setting part 113 changes the first area 100 into the valid area if the first area 100 has been set to the invalid area.

The display control part 114 controls the display part 140 in a manner that a display content is displayed on the display part 140. In FIG. 1, the display part 140 displays, as examples of objects, the objects 141a and 141b which can be moved by the drag operation and objects 142a, 142b, and 142c which can be selected by the touch operation. The display control part 114 is also capable of controlling the display part 140 in a manner that a result obtained by executing an application by an operation performed by the user is displayed on the display part 140.

The display part 140 displays an object in accordance with the control performed by the display control part 114. Further, in accordance with the control performed by the display control part 114, the display part 140 may display an application execution result. As described above, the display part 140 may be included in the information processing apparatus 10, or may be present outside the information processing apparatus 10. Note that, the display part 140 includes, for example, a liquid crystal display (LCD), an organic electroluminescence (EL) display device, and the like.

According to such control, in the case where a substance (for example, water) comes into contact with the invalidation area when the user is not performing operation on the touch panel 130, the operation of touching the first area 100 with the substance is disabled. On the other hand, in the case where the user unintentionally touches the invalidation area during the operation on the touch panel 130, the operation of touching the first area 100 with the substance remains valid. Accordingly, it is expected that the operability on the touch panel 130 is improved without deteriorating waterproof properties.

As described above, the first area 100 may be provided in a central area of the touch panel 130, but since the first area 100 is not particularly limited, the first area 100 may be provided at another position. For example, the first area 100 may be an area of a predetermined object which can be operated by the contact of the operating object with the touch panel 130.

For example, as shown in FIG. 1, the first area 100 may be any one of the object 141a or 141b which can be moved by the drag operation, and may be any one of the object 142a, 142b, or 142c which can be selected by the touch operation. In this case, in the case where the user unintentionally touches the invalidation area during the operation on an object, the operation of touching the first area 100 with the substance remains valid.

However, in the case where the substance is brought into contact with the first area 100 and the second area 200 is changed from the invalidation area into the validation area, it is desired that the second area 200 is changed from the validation area back to the invalidation area at an appropriate timing. This is because malfunction may occur, for example, when water comes into contact with the touch panel 130.

Accordingly, it is desired that the determination part 112 determines whether a predetermined condition for switching the second area 200 to the invalidation area is satisfied. In this case, in the case where it is determined by the determination part 112 that the predetermined condition is satisfied, it is desired that the setting part 113 switches the second area 200 to the invalidation area. Hereinafter, there will be described examples of the predetermined conditions for switching the second area 200 to the invalidation area.

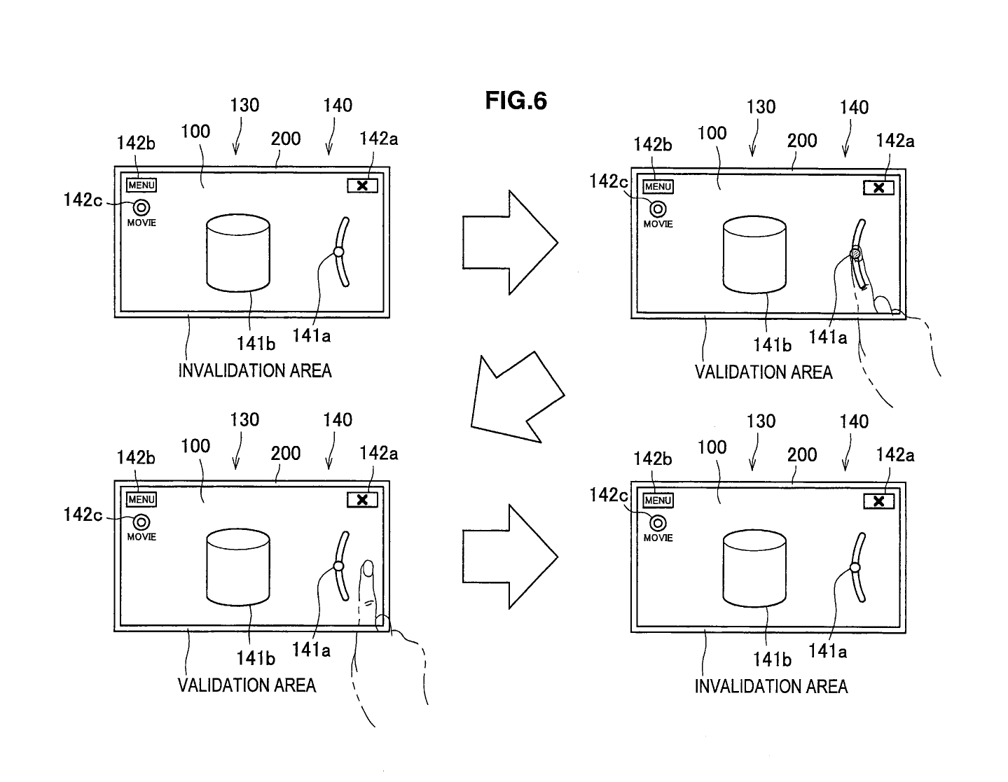

FIG. 6 is a diagram illustrating an example of functions of the information processing apparatus 10 according to an embodiment of the present disclosure. The determination part 112 may determine whether the predetermined condition is satisfied based on whether the contact of the substance within the first area 100 is released. For example, as shown in FIG. 6, let us assume the situation where the substance is brought into contact with the first area 100 and the second area 200 is changed from the invalidation area to the validation area. Under such a situation, in the case where the contact of the substance within the first area 100 is released, the determination part 112 may determine that the predetermined condition is satisfied.

Next, as shown in FIG. 6, in the case where the determination part 112 determines that the contact of the substance within the first area 100 is released, the setting part 113 may regard that the predetermined condition is satisfied and may switch the second area 200 to the invalidation area. This is because, in the case where the contact of the substance within the first area 100 is released, it is likely that the user has finished the operation on the touch panel 130, and hence, it is considered that the convenience of the user is not particularly deteriorated even if the second area 200 is changed back to the invalidation area.

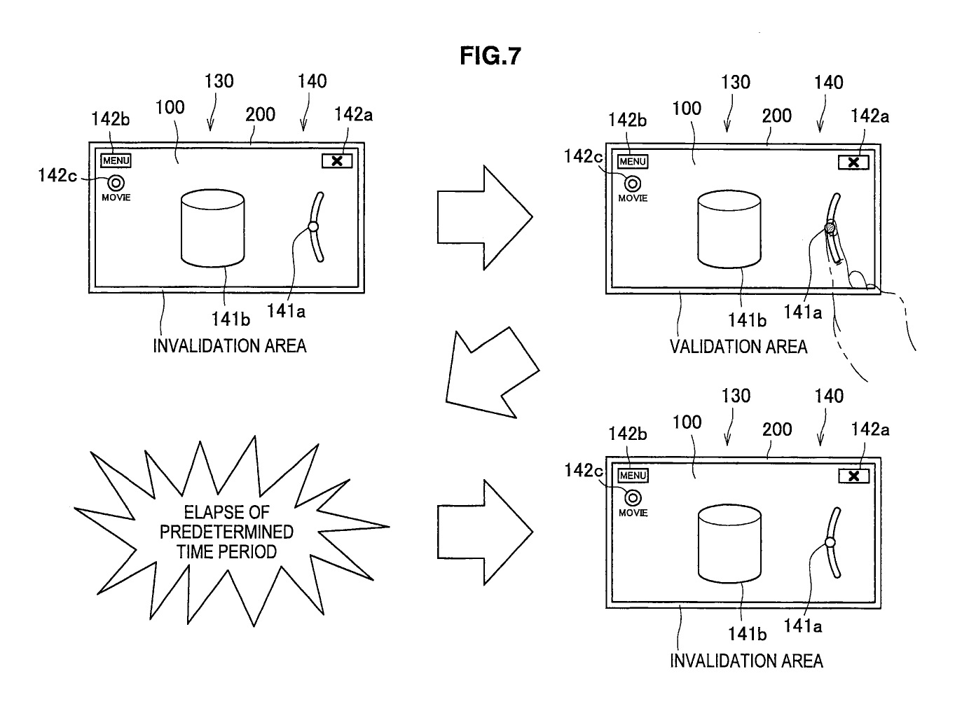

FIG. 7 is a diagram illustrating another example of the functions of the information processing apparatus 10 according to an embodiment of the present disclosure. The determination part 112 may determine whether the predetermined condition is satisfied based on whether a predetermined time period has elapsed since the substance comes into contact within the first area 100. For example, as shown in FIG. 7, let us assume the situation where the substance is brought into contact with the first area 100 and the second area 200 is changed from the invalidation area to the validation area. Under such a situation, in the case where the predetermined time period has elapsed since the substance comes into contact within the first area 100, the determination part 112 may determine that the predetermined condition is satisfied.

Next, as shown in FIG. 7, in the case where the determination part 112 determines that the predetermined time period has elapsed since the substance comes into contact within the first area 100, the setting part 113 may regard that the predetermined condition is satisfied and may switch the second area 200 to the invalidation area. This is because, in the case where the predetermined time period has elapsed since the substance comes into contact within the first area 100, it is likely that the user has had enough time for performing operation on the touch panel 130, and hence, it is considered that the convenience of the user is not particularly deteriorated even if the second area 200 is changed back to the invalidation area.

Heretofore, there have been described examples of the predetermined conditions for switching the second area 200 to the invalidation area. Note that, although there have been described on the examples in which the second area 200 is set to the validation area when the first area 100 is touched in the above, the second area 200 may stay as the invalidation area depending on the number of contacts of the substance with the touch panel 130. This is because, depending on the number of contacts of the substance with the touch panel 130, there are some cases where it can be clearly determined that the user is not performing operation. Hereinafter, there will be described a case where the number of contacts of the substance with the touch panel 130 is taken into account.

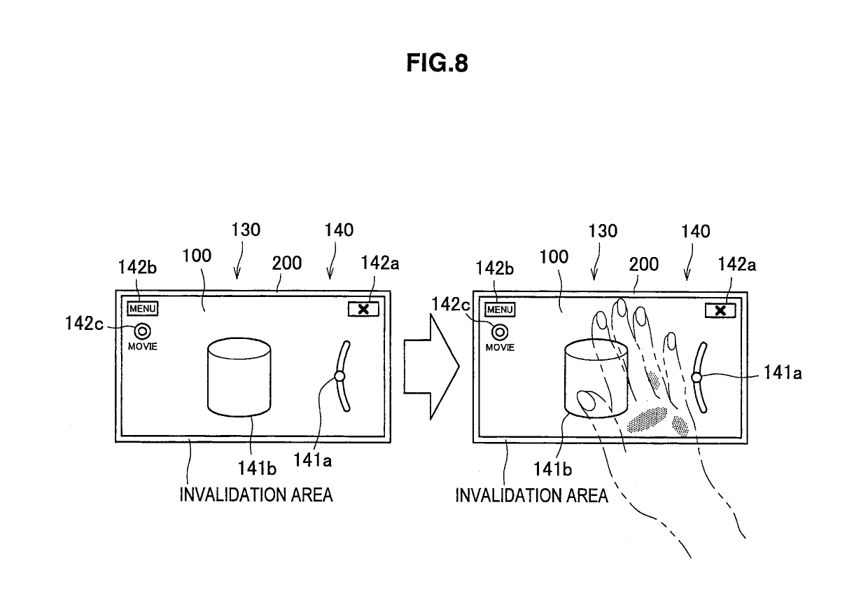

FIG. 8 is a diagram illustrating another example of the functions of the information processing apparatus 10 according to an embodiment of the present disclosure. When the touch panel 130 is used, there is a case where a maximum number of contacts is determined, the maximum number of contacts being for handling the contacts of the substance with the touch panel 130 as a valid operation. For example, in the case where one contact of the operating object with the touch panel 130 is handled as the valid operation, such as the drag operation and the touch operation, the maximum number of contacts is determined to be “1”.

On the other hand, in the case where one contact is handled as the valid operation and two contacts of the operating object with the touch panel 130 are also handled as the valid operation, the maximum number of contacts is determined to be “2”. Examples of the cases where two contacts are handled as the valid operation include an operation of spreading out two fingers in contact with the touch panel 130 (hereinafter, also referred to as “pinch-open operation”), and an operation of tightening two fingers in contact with the touch panel 130 (hereinafter, also referred to as “pinch-close operation”).

In this way, when the maximum number of contacts is determined, in the case where the number of contacts of the substance with the touch panel 130 exceeds the maximum number of contacts, it can be clearly determined that the user is not performing operation. Accordingly, in the case where it is determined that a contact position detected by the detection part 111 is present within the first area 100, the determination part 112 may further determine whether the number of contacts of the substance with the touch panel 130 exceeds the maximum number of contacts. In this case, in the case where the determination part 112 determines that the number of contacts does not exceed the maximum number of contacts, the setting part 113 may set the second area 200 to a validation area.

In the example shown in FIG. 8, there is assumed the situation where the maximum number of contacts is determined to be “2”. Under such a situation, in the case where the number of contacts of the substance with the touch panel 130 is “3” as shown in FIG. 8, the determination part 112 determines that the number of contacts of the substance with the touch panel 130 exceeds the maximum number of contacts. In this case, the setting part 113 may render the second area 200 to stay as the invalidation area. On the other hand, for example, in the case where the number of contacts of the substance with the touch panel 130 is “2”, the determination part 112 determines that the number of contacts of the substance with the touch panel 130 does not exceed the maximum number of contacts. In this case, the setting part 113 may set the second area 200 to the validation area.

Heretofore, functions of the information processing apparatus 10 according to an embodiment of the present disclosure have been described. Subsequently, operation of the information processing apparatus 10 according to an embodiment of the present disclosure will be described.

### 3. OPERATION OF INFORMATION PROCESSING APPARATUS

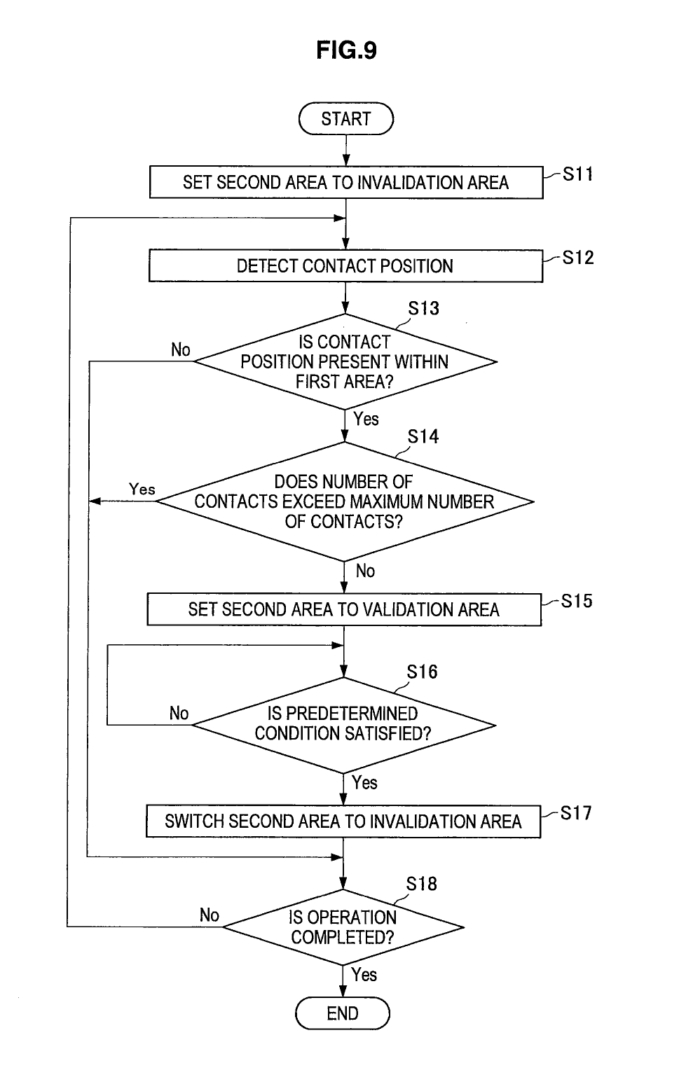

FIG. 9 is a flowchart showing a flow of operation of the information processing apparatus 10 according to an embodiment of the present disclosure. Note that, since the operation shown in FIG. 9 merely shows an example of operation of the information processing apparatus 10, the operation of the information processing apparatus 10 is not limited to the flow of operation shown in FIG. 9.

First, the setting part 113 sets the second area 200 provided on the touch panel 130 to the invalidation area (S11). Subsequently, the detection part 111 detects a contact position of a substance with the touch panel 130 (S12). The determination part 112 determines whether the contact position detected by the detection part 111 is present within the first area 100 (S13). In the case where the determination part 112 determines that the contact position is not present within the first area 100 (“No” in S13), the processing proceeds to S18. On the other hand, in the case where the determination part 112 determines that the contact position is present within the first area 100 (“Yes” in S13), the processing proceeds to S14.

Subsequently, the determination part 112 determines whether the number of contacts of the substance with the touch panel 130 exceeds a maximum number of contacts (S14). In the case where the determination part 112 determines that the number of contacts of the substance with the touch panel 130 exceeds the maximum number of contacts (“Yes” in S14), the processing proceeds to S18. On the other hand, in the case where the determination part 112 determines that the number of contacts of the substance with the touch panel 130 does not exceed the maximum number of contacts (“No” in S14), the setting part 113 sets the second area 200 to the validation area (S15), and the processing proceeds to S16.

Subsequently, the determination part 112 determines whether a predetermined condition for switching the second area 200 to the invalidation area is satisfied (S16). In the case where the determination part 112 determines that the predetermined condition is not satisfied (“No” in S16), the processing returns to S16. On the other hand, in the case where the determination part 112 determines that the predetermined condition is satisfied (“Yes” in S16), the setting part 113 switches the second area 200 to the invalidation area (S17), and the processing proceeds to S18.

In the case where the operation is not completed (“No” in S18), the control part 110 brings the operation back to S12, and when the operation is to be completed (“Yes” in S18), the control part 110 completes the operation.

Heretofore, there has been described operation of the information processing apparatus 10 according to an embodiment of the present disclosure. In the above, there has been assumed as an example the situation in which the user unintentionally touches the second area 200 while moving a slider having a curved shape like the object 141a. However, the object to be moved by the user is not particularly limited. The followings are examples of cases where it is assumed that the user unintentionally touches the second area 200.

### 4. MODIFIED EXAMPLE

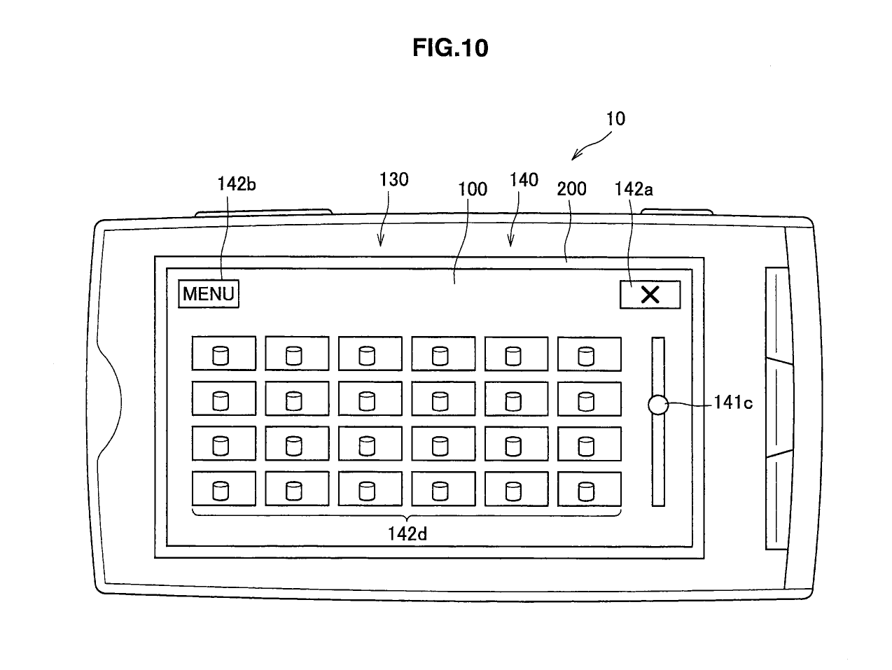

FIG. 10 is a diagram showing an example of an outline of the information processing apparatus 10 according to an embodiment of the present disclosure. As shown in FIG. 10, the display part 140 displays an object 141c which can be moved by a drag operation as an example of an object. Further, the display part 140 displays objects 142a, 142b, and 142d which can be selected by a touch operation as examples of objects. As the example shown in FIG. 10, it is highly likely that, also while moving a slider having a linear shape like the object 141c, the user may touch the second area 200 unintentionally.

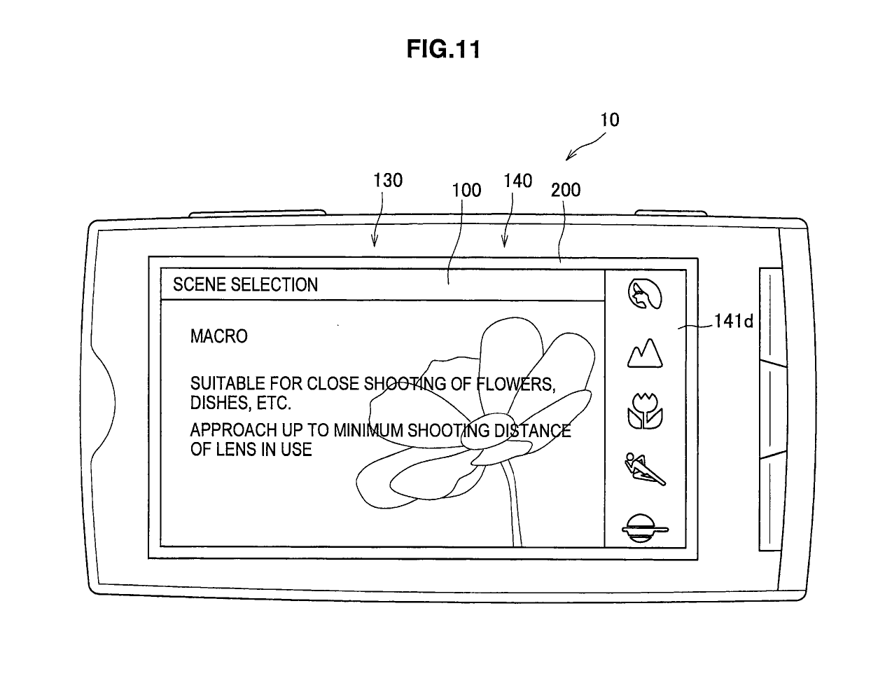

FIG. 11 is a diagram showing an example of an outline of the information processing apparatus 10 according to an embodiment of the present disclosure. As shown in FIG. 11, the display part 140 displays an object 141d which can be moved by the drag operation as an example of an object. As the example shown in FIG. 11, it is highly likely that, also while moving a slot having a linear shape like the object 141d, the user may touch the second area 200 unintentionally.

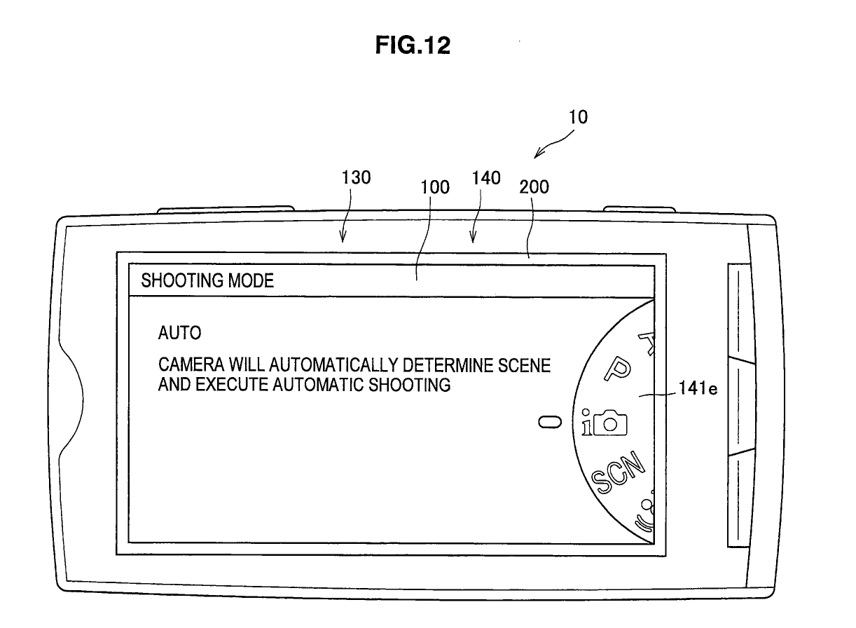

FIG. 12 is a diagram showing an example of an outline of the information processing apparatus 10 according to an embodiment of the present disclosure. As shown in FIG. 12, the display part 140 displays an object 141e which can be moved by the drag operation as an example of an object. As the example shown in FIG. 12, it is highly likely that, also while moving a slot having a disc shape like the object 141e, the user may touch the second area 200 unintentionally.

### 5. CONCLUSION

As described above, according to an embodiment of the present disclosure, there is provided the information processing apparatus 10 including: the detection part 111 which detects a contact position of a substance with the touch panel 130 having the first area 100 and the second area 200 that is set to the invalidation area in which the operation of touching the first area 100 with a substance is disabled by a contact of a substance; the determination part 112 which determines whether the contact position is present within the first area 100; and the setting part 113 which, in the case where the determination part 112 determines that the contact position is present within the first area 100, sets the second area 200 to the validation area in which the operation of touching the first area 100 with a substance is enabled by a contact of a substance.

According to such a configuration, it becomes possible to improve operability on the touch panel without deteriorating waterproof properties. Further, in the case where the second area 200 of the touch panel 130 is set to the validation area, object(s) can be arranged also in the second area 200. When the object(s) arranged in the second area 200 can be selected by the user, the user can receive an advantage that the range from which the object(s) can be selected extends.

It should be understood by those skilled in the art that various modifications, combinations, sub-combinations and alterations may occur depending on design requirements and other factors insofar as they are within the scope of the appended claims or the equivalents thereof.

Further, respective steps included in the operation of the information processing apparatus 10 of the present specification are not necessarily processed in chronological order in accordance with the flowchart. For example, the respective steps included in the operation of the information processing apparatus 10 may be processed in different order from the flowcharts, or may be processed in a parallel manner.

Further, it is also possible to create a computer program for causing hardware such as a CPU, a ROM, and a RAM, which are built in the information processing apparatus 10, to exhibit equivalent functions as those of respective structures of the information processing apparatus 10 described above. Further, there is also provided a storage medium having the computer program stored therein.

Additionally, the present technology may also be configured as below.

(1) An information processing apparatus including:

a detection part configured to detect a contact position of a substance with a touch panel having a first area and a second area, the second area being set to an invalidation area in which an operation of touching the first area with a substance is disabled by a contact of a substance;

a determination part configured to determine whether the contact position is present within the first area; and

a setting part configured to set the second area to a validation area in which an operation of touching the first area with a substance is enabled by a contact of a substance, in a case where the determination part determines that the contact position is present within the first area.

(2) The information processing apparatus according to (1),

wherein the determination part determines whether a predetermined condition for switching the second area to the invalidation area is satisfied, and

wherein, in a case where the determination part determines that the predetermined condition is satisfied, the setting part switches the second area to the invalidation area.

(3) The information processing apparatus according to (2),

wherein the determination part determines whether the predetermined condition is satisfied based on whether a contact of a substance within the first area is released, and

wherein, in a case where the determination part determines that the contact of the substance within the first area is released, the setting part switches the second area to the invalidation area.

(4) The information processing apparatus according to (2),

wherein the determination part determines whether the predetermined condition is satisfied based on whether a predetermined time period has elapsed since a substance comes into contact within the first area, and

wherein, in a case where the determination part determines that the predetermined time period has elapsed since the substance comes into contact within the first area, the setting part switches the second area to the invalidation area.

(5) The information processing apparatus according to any one of (1) to (4),

wherein the first area is an area of a predetermined object which can be operated by a contact of an operating object with the touch panel.

(6) The information processing apparatus according to any one of (1) to (5),

wherein, in a case where the determination part determines that the contact position is present within the first area, the determination part further determines whether a number of contacts of a substance with the touch panel exceeds a maximum number of contacts, the maximum number of contacts being for handling the contacts of the substance with the touch panel as a valid operation, and

wherein, in a case where the determination part determines that the number of contacts does not exceed the maximum number of contacts, the setting part sets the second area to the validation area.

(7) An information processing method including:

detecting a contact position of a substance with a touch panel having a first area and a second area, the second area being set to an invalidation area in which an operation of touching the first area with a substance is disabled by a contact of a substance;

determining whether the contact position is present within the first area; and

setting the second area to a validation area in which an operation of touching the first area with a substance is enabled by a contact of a substance, in a case where it is determined that the contact position is present within the first area.

(8) A program for causing a computer to function as an information processing apparatus which includes

a detection part configured to detect a contact position of a substance with a touch panel having a first area and a second area, the second area being set to an invalidation area in which an operation of touching the first area with a substance is disabled by a contact of a substance,

a determination part configured to determine whether the contact position is present within the first area, and

a setting part configured to set the second area to a validation area in which an operation of touching the first area with a substance is enabled by a contact of a substance, in a case where the determination part determines that the contact position is present within the first area.

The present disclosure contains subject matter related to that disclosed in Japanese Priority Patent Application JP 2012-014486 filed in the Japan Patent Office on Jan. 26, 2012, the entire content of which is hereby incorporated by reference.

What is claimed is:

1. An information processing apparatus comprising:
a detection part configured to detect a contact position of a substance with a touch panel having a first area and a second area, the second area being set to an invalidation area in which an operation of touching the first area with a substance is disabled by a contact of a substance;
a determination part configured to determine whether the contact position is present within the first area; and
a setting part configured to set the second area to a validation area in which an operation of touching the first area with a substance is enabled by a contact of a substance, in a case where the determination part determines that the contact position is present within the first area.

2. The information processing apparatus according to claim 1,
wherein the determination part determines whether a predetermined condition for switching the second area to the invalidation area is satisfied, and
wherein, in a case where the determination part determines that the predetermined condition is satisfied, the setting part switches the second area to the invalidation area.

3. The information processing apparatus according to claim 2,
wherein the determination part determines whether the predetermined condition is satisfied based on whether a contact of a substance within the first area is released, and
wherein, in a case where the determination part determines that the contact of the substance within the first area is released, the setting part switches the second area to the invalidation area.

4. The information processing apparatus according to claim 2,
wherein the determination part determines whether the predetermined condition is satisfied based on whether a predetermined time period has elapsed since a substance comes into contact within the first area, and
wherein, in a case where the determination part determines that the predetermined time period has elapsed since the substance comes into contact within the first area, the setting part switches the second area to the invalidation area.

5. The information processing apparatus according to claim 1,
wherein the first area is an area of a predetermined object which can be operated by a contact of an operating object with the touch panel.

6. The information processing apparatus according to claim 1,
wherein, in a case where the determination part determines that the contact position is present within the first area, the determination part further determines whether a number of contacts of a substance with the touch panel exceeds a maximum number of contacts, the maximum number of contacts being for handling the contacts of the substance with the touch panel as a valid operation, and
wherein, in a case where the determination part determines that the number of contacts does not exceed the maximum number of contacts, the setting part sets the second area to the validation area.

7. An information processing method comprising:
detecting a contact position of a substance with a touch panel having a first area and a second area, the second area being set to an invalidation area in which an operation of touching the first area with a substance is disabled by a contact of a substance;
determining whether the contact position is present within the first area; and
setting the second area to a validation area in which an operation of touching the first area with a substance is enabled by a contact of a substance, in a case where it is determined that the contact position is present within the first area.

8. A program for causing a computer to function as an information processing apparatus which includes
a detection part configured to detect a contact position of a substance with a touch panel having a first area and a second area, the second area being set to an invalidation area in which an operation of touching the first area with a substance is disabled by a contact of a substance,
a determination part configured to determine whether the contact position is present within the first area, and
a setting part configured to set the second area to a validation area in which an operation of touching the first area with a substance is enabled by a contact of a substance, in a case where the determination part determines that the contact position is present within the first area.
